(19) United States
(12) Patent Application Publication
(10) Pub. No.: US 2005/0261885 A1
(43) Pub. Date: Nov. 24, 2005

(54) Method and apparatus for formal circuit verification

(75) Inventor: Holger Busch, Brunnthal-Otterloh (DE)

Correspondence Address: BRINKS HOFER GILSON & LIONE;INFINEON, PO BOX 10395, CHICAGO, IL, 60610, US

(73) Assignee: Infineon Technologies AG

(21) Appl. No.: 11/190,754

(22) Filed: Jul. 26, 2005

Related U.S. Application Data
(63) Continuation of application No. PCT/EP04/00737, filed on Jan. 28, 2004.

(30) Foreign Application Priority Data
Jan. 30, 2003 (DE) DE 103 03 684.9

(51) Int. Cl. G06F 17/50

(52) U.S. Cl. 703/14

(57) ABSTRACT

A method and apparatus for determining the time behavior of a digital circuit based on a starting assumption is disclosed. Generally, in a formal verification of a digital circuit, the time behavior of a digital circuit is monitored to verify or refute whether formulated properties, which comprise an assumption and an assertion, result as a consequence of a presence of an assumption in the digital circuit. In order to determine the behavior of the digital circuit, the time behavior of the digital circuit is examined from a starting initial state of the digital circuit. A relevant auxiliary property is activated and the assertion of the auxiliary property is added to the digital circuit. The digital circuit is then monitored over a period of time.

### RELATED APPLICATIONS

The present patent document is a Continuation application of PCT Application No. PCT/EP2004/00737, filed Jan. 28, 2004, which claims priority to German Patent No. DE 103 03 684.9, filed Jan. 30, 2003, the entirety of which are both hereby incorporated by reference.

### FIELD OF THE INVENTION

The present invention relates to a method and apparatus for the formal verification of a digital circuit.

### BACKGROUND OF THE INVENTION

The present invention relates, in particular, to the verification of designs of a digital circuit which, on account of its complex behavior, may not be adequately tested by means of simulation. In such cases, a mathematically based model test is normally used, wherein formal properties of this circuit are specified and it is formally checked whether the current circuit model exhibits this property. In the checking of formal properties of a digital circuit, possible results are that a specific property is applicable or is not applicable, or that it is not possible to check whether or not the property is applicable.

### BRIEF SUMMARY

A property, in the sense of the present invention, has an assumption and an assertion. A property is applicable or the circuit possesses this property if the assertion is realized or is applicable when the assumption is present, both the assumption and the assertion of the property being descriptions of the state of the circuit while allowing for time or relative time relationships. A circuit description of this type does not illustrate the state of the circuit completely, but rather merely comprises individual state predicates. An individual state predicate of this type may prescribe, for example, the logic state of a signal line within the circuit, the content of a register or a relation between a plurality of signals. State descriptions will generally reflect only the state of a few parts of the circuit.

A state description as an element of a property also has a time component, so a circuit state is detected not only at a specific instant, but also over a specific number of time steps or over a specific period. Changes in logic states of specific signals or of a register content, in particular, along with the temporal relative position of said signals, may thus be detected.

In principle, in the definition of such formal properties, a formal description is produced of the circuit, which is abstract and possesses far fewer details than the complete circuit design.

In the formulation of a property, an assumption, which describes specific time behavior of selected parts of the circuit over time, is defined and an assertion, which also describes the time behavior of selected parts of the circuit, is formulated.

The assumption and assertion of a property are generally in a fixed temporal relation to each other, so the changes in state defined by the assertion of a property, defined temporally with respect to the changes in state in the assumption, occur when the property is applicable. The time ranges spanned by the assumption and the assertion of a property generally overlap. The total time frame spanned by a property is designated as the interval of the property. Observation of the state of the circuit over this interval of a property is not required for this specific property.

The assumption and the assertion of a property may be defined using concepts from ITL (interval temporal logic). An identifier for a specific instant, for example t, may be introduced in a property as a time reference point. Individual states or changes in state are then described in relation to this instant, the relative position, in particular, being expressed by means of time steps; an instant located five time steps after the reference instant, for example, would be denoted by t+5.

The object of the present invention is to provide a method and also a device configured for carrying out the method, with which a formal verification of a digital circuit may be carried out at low cost and also for long property intervals.

According to the invention, auxiliary properties are used as a basis which are, in particular, already formally proven properties and thus reliably describe the behavior of the relevant digital circuit under the respective assumptions of the individual auxiliary properties. Moreover, a start assumption, which is also a description of the state of the circuit while allowing for time, is specified. The start assumption for the circuit therefore corresponds substantially to an assumption of an auxiliary property.

Moreover, an accumulated assumption, which is also, like the start assumption, a description of the state of the digital circuit while allowing for time, is defined. The accumulated assumption is examined repeatedly in an assumption examination in order to establish whether the assumption includes an auxiliary property with limited time shifting. If this is the case, this auxiliary property is activated or the assertion of this auxiliary property is added to the accumulated assumption. The assertion of this activated auxiliary property therefore represents the consequence that occurs on the basis of the presence of the assumption for this auxiliary property.

Advantageously, the assumption examination is carried out every time the accumulated assumption has changed, as in this case the accumulated assumption might in the meantime have acquired new assumptions of auxiliary properties, so these might be activated.

In this way, the accumulated assumption is developed iteratively by application of the auxiliary properties.

In the development of the accumulated assumption, it must generally also be taken into account in what temporal position, in relation to the current accumulated assumption, the assumptions for an auxiliary property may be fulfilled and in what temporal position, relative to the accumulated assumption, the assertion of an activated auxiliary property occurs, in order to be able to add the assertion of an activated auxiliary property having the correct time relationship to the accumulated assumption.

Advantageously, interrelationships between the individual auxiliary properties, which indicate how the presence of the assumption of an auxiliary property affects the presence of the assumption of another auxiliary property, are determined. In other words, an interrelation of this type describes whether information may be derived from the activation of an auxiliary property in relation to the activation of at least one other auxiliary property in a suitable relative time shift. Such a dependency may be produced in various ways. For example, the assumptions of two auxiliary properties may be identical, so on activation of one auxiliary property, the other auxiliary property is also automatically activated. In such a case, however, the two auxiliary properties could also be combined to form a single auxiliary property having the same assumption in that the two assertions of the two auxiliary properties are added.

A mutual dependency of two auxiliary properties may also be produced in that the assumption and the assertion of a first auxiliary property combined include the assumption of a second auxiliary property, so on activation of the first auxiliary property and addition of the assertion of the first auxiliary property to the accumulated assumption, the assumption for the second auxiliary property is automatically provided, said second auxiliary property thus being activated.

Moreover, interrelationships are also possible which indicate that the activation of a second auxiliary property is ruled out on activation of a first auxiliary property, wherein this exclusion of the activation of the second auxiliary property may also be displayed as a function of a specific time relationship between the two auxiliary properties. This mutual exclusion may occur because the assumptions of the two auxiliary properties rule one another out, or because the assertion of the first auxiliary property rules out the assumption for the second auxiliary property. Such interrelationships, which have been determined once beforehand, between auxiliary properties dispense with the need for subsequent individual examinations as to whether assumptions of auxiliary properties ensue from the accumulated assumption or are in opposition thereto.

As soon as the accumulated assumption includes the assumption of an auxiliary property, this auxiliary property is activated. At what instant this takes place and at what instant the assertion of this activated auxiliary property occurs depends on the relative temporal position in relation to the accumulated assumption of the descriptions of the state of the auxiliary property. In an advantageous embodiment of the present invention, the time relationships of the activation or non-activation of auxiliary properties are illustrated in an activation matrix. In this activation matrix, it is specified for each auxiliary property, for at least one time shift step, whether the respective auxiliary property is activated or deactivated, or whether it is not possible to issue a statement in this regard, or it is still undecided and is still possible, should the accumulated assumption change, that the auxiliary property for the respective time shift step may be activated or deactivated. The advantageous incorporation of the time shift or the time relationship to the accumulated assumption is necessary if the accumulated assumption, like the assumptions of the auxiliary properties, represents the state of the circuit over a specific period, and thus contains the indication that a specific auxiliary function is activated or deactivated, given the current accumulated assumption, and advantageously also contains the indication of the instant or time relationship at which the activation or deactivation occurs.

For this purpose, a line vector, the individual elements of which indicate the state of activation of the auxiliary property for a specific time shift or a specific time relationship to the accumulated assumption, may be specified in the activation matrix for each auxiliary property, wherein the time shift is time-discrete and may be illustrated by a specific number of time steps, which may, for example, correspond to the system clock of the digital circuit. The state of activation for a specific auxiliary property for a specific time shift, which may also be viewed as the offset of the auxiliary property with respect to the accumulated assumption, may contain the indications “Activated”, “Deactivated” or “Undecided”, the indication “Undecided” expressing that it is not possible to say, for this auxiliary property and this time shift, whether the auxiliary property is activated or deactivated. The indication “Activated” means that the respective auxiliary property is activated at the relevant time shift. Correspondingly, the indication “Deactivated” means that the auxiliary property for this time shift is deactivated, and the indication “Undecided” means that it is possible, according to the current state of the accumulated assumption, that the auxiliary property may be activated or else deactivated at the relevant time shift, depending on the subsequent development of the accumulated assumption.

As soon as the statement “Activated” is issued in the activation matrix for a specific auxiliary property, the assertion of this auxiliary property is added to the accumulated assumption at the correct instant. It is thus advantageously ensured that the entry “Activated” in the activation matrix leads only once to the addition of the assertion of the respective auxiliary property. However, this does not rule out the possibility that the same auxiliary property may be activated once again with a different time shift.

When carrying-out the method, the accumulated assumption and the activation matrix are thus developed to the same degree, wherein each time the activation state “Activated” is entered, the corresponding auxiliary property is activated and the assertion thereof incorporated into the accumulated assumption.

If it should occur that no more auxiliary properties may be activated on the basis of the accumulated assumption alone, sub-cases, in which the accumulated assumption is in each case separately enhanced with the respective requirement of the sub-case, are automatically generated on the basis of specified case differentiation rules. The proof objective and the activation matrix are thus divided in accordance with the number of sub-cases. An individual accumulated assumption and an individual activation matrix are provided for each sub-case. This method is used only if auxiliary rules are activated.

The method terminates, depending on the proof objective, when the assertion had been reduced to True or False, when activation of time-shifted auxiliary properties may no longer be achieved even with case differentiations, when all of the time shifts that may still be activated of auxiliary properties are located outside the time window of a proof objective, or when the activation matrix assumes for a time step a state already provided in identical form at an earlier time step, without a reduction of the assertion of a proof objective occurring, so merely an already provided substring of auxiliary properties is duplicated in time-shifted form.

The individual auxiliary properties may be converted, prior to use in the method according to the invention, in accordance with the general rules. It is, for example, possible to apportion an auxiliary property into a plurality of auxiliary properties, wherein the apportionment may correspond to time, in order to reduce the interval of the auxiliary property, or a subdivision may correspond to the cases of application, in order to achieve a case differentiation. Causal dependencies between the parts of the auxiliary property are introduced, and this ensures the chronologic activation of the part properties in accordance with their temporal position within the interval of the complete auxiliary property. This allows parts of an auxiliary property to be activated as soon as parts of the assumption of said auxiliary property have been fulfilled on the basis of the accumulated assumption.

For carrying out the method, symbols, which form the input variables for the method, are allocated, in particular, to the individual signals of the circuit. These variables do not initially contain any information regarding their mutual dependencies, which generally occur in the signals in a specific circuit. Thus, for example, two states may rule each other out if, for example, the first state is the negation of the second state. This information is not initially contained in the associated symbols. In order, nevertheless, to render this information accessible when carrying out the method, the logic dependencies between the associated symbols are stored. This may take place, for example, in the conjunctive normal form, in which, for example, the list [a₁, . . . , aₘ], [b₁ . . . , bₙ], . . . corresponds to the logic function NOT (a₁\hat{ } . . . \hat{ }aₘ)\hat{ }NOT (b₁\hat{ } . . . \hat{ }bₙ)\hat{ } . . . . Such a dependency may, for example, be produced as a result of the mutual exclusion of two states, or because a state includes a second state, if, for example, the first state only indicates x<5 and the second state indicates x=2, so the second state necessarily includes the first state.

In a particularly preferred embodiment, the present invention is used in order to examine a circuit property to be proven. The property to be proven will be referred to below as the proof objective and possesses, like the auxiliary properties, an assumption and an assertion. The aim of the investigation is to verify the proof objective, i.e. to state whether the property is applicable or is not applicable. The assumption of the proof objective is used as a start assumption and, on the basis of this, the accumulated assumption according to the method of the invention is developed with the aid of the auxiliary properties. At the same time, it is checked whether the accumulated assumption includes the assertion of the proof objective. If this is the case, it may thus be proven that if the assumption of the proof objective is present, the assertion of the proof objective is also applicable, thus allowing the proof objective to be verified. If, on the other hand, during the development of the accumulated assumption, the state occurs that no more auxiliary properties are activated and the achieved accumulated assumption does not include the assertion of the proof objective, the proof objective may not be inferred, as the amount of the specified auxiliary properties is not sufficient to invalidate the proof objective. The current state of the accumulated assumption and the reduced assertion of the proof objective, and the activation matrix provide purposeful indications of missing auxiliary properties. The remaining proof objective may optionally be proven by a model-based identifier. If, in the reduction of the assertion of the proof objective, the case occurs that the remaining assertion is in opposition to the accumulated assumption, the proof objective is refuted. In this case, the chain of activations of auxiliary properties from which the opposition was generated may be retraced.

### BRIEF DESCRIPTION OF THE DRAWINGS

The invention will be described below in greater detail on the basis of a preferred embodiment, with reference to the attached drawings, in which:

FIG. 1 shows a proof objective to be proven comprising an assumption and an assertion;

FIG. 2 shows three auxiliary properties, each comprising an assumption and an assertion;

FIG. 3 shows the accumulated assumption after the first iteration step; and

FIG. 4 shows the accumulated assumption at the end of the iteration.

### DETAILED DESCRIPTION OF THE DRAWINGS AND THE PRESENTLY PREFERRED EMBODIMENTS

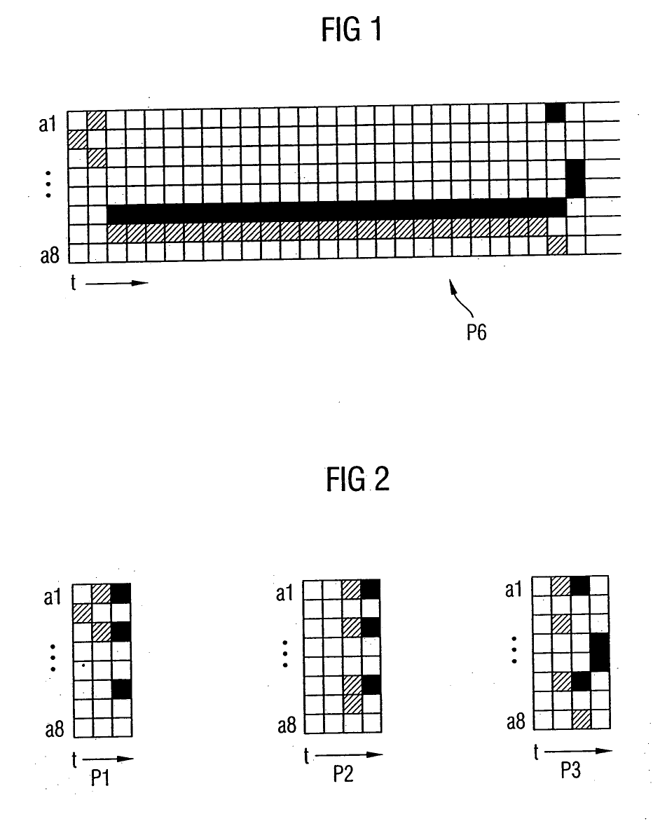

FIG. 1 shows a proof objective PG to be proven. The proof objective PG possesses an assumption and an assertion, which are each descriptions of the state of a circuit illustrated over time t. The time t is divided into individual time steps. The state of the circuit is described by binary values of individual state predicates a₁ to a₈, which are each allocated a line of the matrix illustrated in FIG. 1. In the present embodiment, a specific property PG of an interrupt controller is to be verified, the observation of eight state predicates a₁ to a₈ being all that is required for the verification of the proof objective. These eight state predicates a₁ to a₈ have the following meanings:
a₁:=data=$d, a₂:=state=idle, a₃:=state=risc, a₄:=state=rdy, a₅:=req=0, a₆:=req=1, a₇:=ack+0, a₈:=ack=1.

In FIG. 1, the assumption of the proof objective is PG illustrated by hatching and the assertion of the proof objective PG by black areas. An empty box means FALSE or that a state predicate is not applicable at a specific relative point in time.

The proof objective PG to be proven may be formulated in ITL as follows, the assumption being separated from the assertion by the characters |:
t_{req}=t+2, t_{ack}=r_{req}+23
at t_{req}−2: state=idle, at t_{req}−1: state=risc \hat{ } data=$d,
during [t_{req}, t_{ack}--1: ack=0,
at t_{ack:}: ack=1
   | during [t_{req}, t_{ack}]: req=1, at t_{ack}: req=1, at t_{ack}: data=$d,
at t_{ack+1}: req=0 \hat{ } state=rdy

The time relationships are based on the first column on the left in the proof objective PG, which column has the time index t, subsequent time steps being plotted to the right. The proof objective PG thus expresses that if at instant t the state is “idle”, at instant t+1 the state is “risc” and a data word “data” is present, during the period t+2 to t+24 ack=0 and at t+25 ack=1, the consequence is that during the period t+2 to t+25 req=1, at t+25 a data word “data” is present, and at t+26 req=0 and the state is rdy.

FIG. 2 shows three auxiliary properties P1 to P3, which are intended to be used for the verification of the proof objective PG. The three auxiliary assumptions P1 to P3 also each contain an assumption and an assertion, which, like the proof objective PG, include descriptions of the state of the eight state predicates a₁ to a₈. The assumptions are also shown by hatching and the assertions by continuous black areas, and the temporal reference point is in each case the column at the left edge.

The three properties P1 to P3 may be formulated as follows:
P1: t_{req}=t+²
   at t_{req}−2: state=idle, at t_{req}−2: state=risc\hat{ }data=$d
         | at t_{req}: state=risc\hat{ }data\hat{ }req=1
P2: t_{req}=t+2,
   at t_{req}: req=1\hat{ }state=risc\hat{ }data=$d\hat{ }ack=0
         | at t_{req}: req=1\hat{ }state=risc\hat{ }data=$d
P3: t_{ack}=t+2,
   at t_{ack}−1: req=1: req=1\hat{ }state=risc\hat{ }data=$d
         | at t_{ack}: req=1\hat{ }data=$d, at t_{ack}+1: req=0\hat{ }state=rdy

Auxiliary state predicates c₁ to c₅, which each represent combinations of the state predicates a₁ to a₈ as follows, are now also introduced:
c₁:a₅\hat{ }a₄, c₂:=a₃\hat{ }a₁,c₃:=a₃\hat{ }a₁\hat{ }a₆, c₄:a₆\hat{ }a₃\hat{ }a₁ a₇, c5:=a₆\hat{ }a₁.

After the introduction of the state predicates a₁ to a₈ and the auxiliary state predicates c₁ to C₅, the proof objective PG and the auxiliary properties P1 to P3 may be converted as follows: PG0: t_{req}=t+2, t_{ack}=t_{req}+23 at t_{req}−2: a₂; at t_{req}−1: a₃, during [t_{req}, t_{ack}−1]: a₇, at t_{ack}: a₈ | during [t_{req}, t_{ack}]: a₆, at t_{ack}: a₁, at t_{ack}+1: c_{1 P1: t}_{req}=t+² at t_{req}−2: a₂, at t_{req}−1: c_{2 | at t}_{req}: c₃ P2: t_{req}=t+2 at t_{req}: c₄ | at t_{req+1}: c₄ P3: t_{ack}=t+2 at t_{ack}−1: c_{4 at t}_{ack}: a₈ | at t_{ack}: c₅, at t_{ack}+1:c₁

The following interrelationships in the conjunctive normal form (cnf) may also be produced from the preceding state predicates a₁ to a₈ and auxiliary state predicates c₁ to c₅;
[a₄, a₅, [symbol] c₁], [ [symbol] a₄, c₁], [ [symbol] a₅, c₁], [a₁, a₃, [symbol] c₂], [ [symbol] a₁, c₂],
[ [symbol] a₃, c₂], [a₁, a₃, a₆, [symbol] c₃], [ [symbol] a₁, c₃], [ [symbol] a₃, c₃], [ [symbol] a₆, c₃],
[ [symbol] a₁, a₃, a₆, a₇, [symbol] c₄], [ [symbol] a₁, c₄], [ [symbol] a₃, c₄], [ [symbol] a₆, C₄],
[ [symbol] a₇, c₄], [a₁, a₆, [symbol] c₅], [ [symbol] a₁, c₅], [ [symbol] a₆, c₅]
   wherein [symbol] denotes a negation and the conjunction of all of the elements of each list produces the truth value FALSE. For example, [symbol] a₄, c₁ rule each other out, so the condition a₄ may be inferred from the presence of c₁, without having each time to analyse the definitions, which are generally much more complex, of these symbols. Moreover, the following relations may be formulated between the state predicates a₁ to a₈:
[a₂, a₃], [a₂, a₄], [a₃, a₄], [a₅, a₆], [ [symbol] a₅, [symbol] a₆], [a₇, a₈], [ [symbol] a₇, [symbol] a₈]

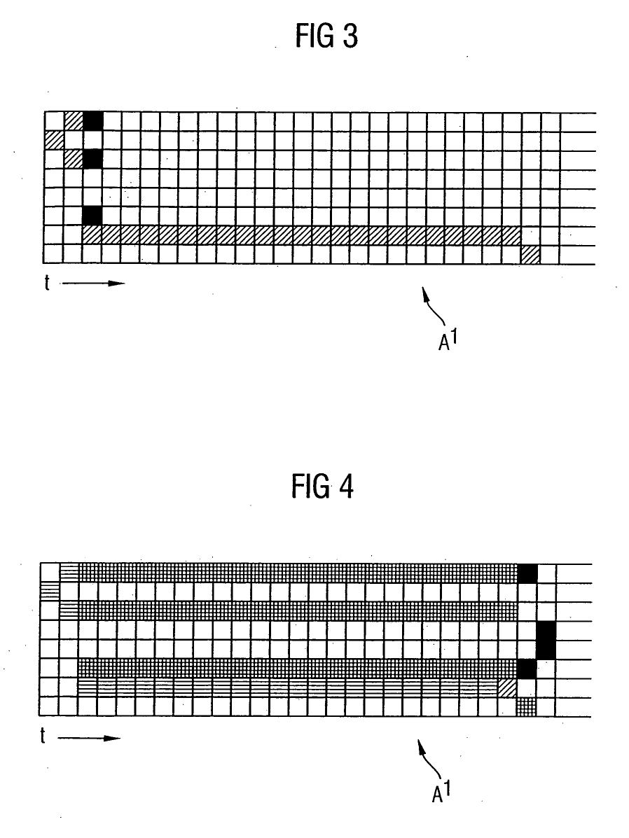

For the verification of the proof objective, the assumption of the proof objective PG as a start assumption of the method that is taken over into an accumulated assumption A, is taken as a starting point. FIG. 3 shows the accumulated assumption A in its state after the first iteration step, so the identifier A¹ is selected. In the accumulated assumption illustrated in FIG. 3, in addition to the start assumption, which comprises only the boxes illustrated by hatching, the assertion of the first auxiliary property P1, which is formed by the three black boxes in the third column, has also been added after the first iteration step. These black boxes have been entered into the accumulated assumption A, as the assumption of the auxiliary property P1 was already contained in the first two columns of the start assumption, so with the time shift “Zero” the auxiliary request P1 was activated, the assertion of the auxiliary property P1 thus being taken over into the accumulated assumption A with the time shift “Zero”. As may clearly be seen, after the first iteration step, the accumulated assumption A¹ illustrated in FIG. 3 now also contains, as a result of the addition of the assertion of the auxiliary property P1, the assumption of the auxiliary property P2, so the assertion of the second auxiliary property P2 is added to a subsequent iteration step (not shown) in the fourth column.

In this way, the state of the accumulated assumption A is successively iteratively continued and it is checked after each change whether the assumption of an auxiliary property P1 to P3 is provided and, if so, at what point. After the activation of an auxiliary property, the assertion of the respective auxiliary property is added at the given point in the accumulated assumption.

The following interrelationships between the auxiliary properties P1 to P3 while allowing for time could be determined in advance, Eₙ denoting the enabling or activation of the auxiliary property n, and Dₙ the disabling or deactivation of the auxiliary property n:
[E₁(t), [symbol] D₁(t−1)], [E₁(t), [symbol] D₁(t+1)], [E₁(t), [symbol] D₁(t+2)]
[E₁(t), [symbol] D₂(t−2)], [E₁(t), [symbol] D₃(t+1)], [E₂(t), [symbol] D₁(t+2)]
[E₂(t), [symbol] D₁(t+3)], [E₂(t), [symbol] D₃(t)],
[E₃(t), [symbol] D₁(t+1)], [E₃(t), [symbol] D₁(t+2)], [E₃(t), [symbol] D₂(t)],
[E₃(t), [symbol] D₂(t+1)], [E₃(t), [symbol] D₃(t+2)]

Once the method according to the invention has been carried out, an accumulated assumption Aⁿ, which is illustrated in FIG. 4, is achieved. The activations entered therein of the individual state predicates are to be read as follows: horizontally hatched boxes denote state predicates that were already contained in the start assumption and have been used as an assumption of an auxiliary property P1 to P3. Boxes having a square pattern denote state predicates that originate from an assertion of an auxiliary property P1 to P3 and have been used as an assumption for an auxiliary property P1 to P3. Black boxes denote state predicates that originate from an assertion of an auxiliary property, in the present case P3, and do not form an assumption for the activation of an auxiliary property P1 to P3.

There is also one box with oblique hatching, which originates from the start assumption, but has not been used as an assumption for the activation of an auxiliary property P1 to P3. It may thus be established that this box with oblique hatching or state predicate was not required for achieving the assertion of the proof objective PG by means of the auxiliary properties P1 to P3.

The method was terminated at the state Aⁿ, as the accumulated assumption A includes the assertion of the proof objective PG. The method would also have been terminated as soon as no more auxiliary properties P1 to P3 could have been activated, so the accumulated assumption A could no longer have been changed. In the latter case, the amount of the auxiliary properties would have been incomplete.

In principle, it is also possible that the assumption of the property PG to be proven is, at least in part, backwardly replaced by the assumption of an auxiliary property, from the assertion of which at least a part of the assertion of the property PG to be proven ensues. The method may thus be shortened, as the realisation of the backwardly replaced parts of the assertion of the property PG to be proven may be inferred from the presence of the assumption of an auxiliary property of this type.

Moreover, it is also possible that the accumulated assumption assumes a state that is in opposition to the assertion of the proof objective PG. In this case, the proof objective PG would be refuted, as the assertion of the proof objective may no longer be realised.

It is therefore intended that the foregoing detailed description be regarded as illustrative rather than limiting, and that it be understood that it is the following claims, including all equivalents, that are intended to define the spirit and scope of this invention.

1. A method for determining the time behavior of a digital circuit based on a starting assumption, comprising:
selecting an accumulated assumption that is the same as a starting assumption;
performing an assumption examination to detect whether at least one assumption of an auxiliary property is present in the accumulated assumption at a predefined time, wherein the at least one auxiliary property indicates a realization of an assertion of the auxiliary property; and
incorporating the assertion of the at least one auxiliary property into the accumulated assumption if the assumption of the at least one auxiliary property is present in the accumulated assumption;
wherein the starting assumption, the assumption, and the assertion describe a state of the digital circuit at predefined times.

2. The method according to claim 1, wherein the assumption examination is performed when the accumulated assumption changes.

3. The method according to claim 1, further comprising:
determining interrelationships between at least two auxiliary properties, wherein the interrelationships indicate how the presence of the assumption of an auxiliary property necessitates the presence of the assumption of at least one other auxiliary property in a suitable time shift.

4. The method according to claim 3, wherein the determining of the interrelationships is based on how the assertion of the auxiliary property includes the assumption of at least one other auxiliary property and/or how the presence of an assumption of an auxiliary property necessitates or rules out the presence of the assumption of at least one other auxiliary property.

5. The method according to claim 1, further comprising:
producing an activation matrix that determines for each auxiliary property whether the auxiliary property is activated, deactivated, or unknown at at least one time shift step of the at least one auxiliary property with respect to the starting assumption.

6. The method according to claim 1, further comprising:
dividing an auxiliary property into auxiliary properties such that the sum of the assertions of the auxiliary properties corresponds to the assertion of the auxiliary property and the sum of the assumptions of the auxiliary properties corresponds to the assumption of the auxiliary property;
wherein mutual causal dependencies of the divided auxiliary properties in the form of a prescribed activation sequence are taken into account in the activation of the individual parts of the auxiliary property.

7. The method according to claim 5, further comprising:
dividing an auxiliary property into auxiliary properties such that the sum of the assertions of the auxiliary properties corresponds to the assertion of the auxiliary property and the sum of the assumptions of the auxiliary properties corresponds to the assumption of the auxiliary property, wherein mutual causal dependencies of the divided auxiliary properties in the form of a prescribed activation sequence are taken into account in an activation of individual parts of the auxiliary property; and
apportioning a proof objective by automatic and controlled case differentiations when at least one auxiliary property is activated, wherein an individual accumulated assumption, an individual activation matrix and an individual correspondingly reduced assertion is generated for each case of the case differentiation.

8. The method according to claim 6, further comprising:
terminating the method if:
the accumulated assumption does not include an assumption of an auxiliary property and the enhancement of the accumulated assumption with partial conditions from case differentiations does not cause an activation of auxiliary properties;
the assertion of a proof objective has been completely invalidated;
all of the auxiliary properties which may still be activated with a suitable time shift are located outside the time window of a proof objective; or
the parts of the activation matrix based at a current time are identical to parts of the activation matrix at an earlier time, and the state of the parts of the activation matrix may no longer be changed.

9. The method according to claim 1, wherein the starting assumption is the assumption of a property to be proven and the starting assumption is examined to determine whether an assertion of the property to be proven is included in the accumulated assumption.

10. The method according to claim 9, further comprising:
replacing an assertion of the property to be proven with the assumption of the auxiliary property.

11. The method according to claim 1, further comprising:
replacing all state predicates occurring in the assumptions and assertions with unambiguous, uninterrupted symbols.

12. The method according to claim 1, wherein causal dependency of the successively activated auxiliary properties are derived from a sequence of the activation of successively activated auxiliary properties.

13. The method according to claim 12, further comprising:
producing an activation matrix comprising for each auxiliary property whether the auxiliary property is activated, deactivated, or unknown at at least one time shift step of the auxiliary property with respect to the starting assumption;
retracing inconsistencies between the assertion and the accumulated assumption in a sequence of activated auxiliary assumptions; and
generating indications for possible completion of an amount of the auxiliary properties as a function of the accumulated assumption, at least one assertion, and the activation matrix.

14. A computer-readable storage medium containing a set of instructions for determining the time behavior of a digital circuit based on a starting assumption, the set of instructions to direct a computer system to perform acts of:
selecting an accumulated assumption that is the same as a starting assumption;
performing an assumption examination to detect whether at least one assumption of an auxiliary property is present in the accumulated assumption at a predefined time, wherein the at least one auxiliary property indicates a realization of an assertion of the auxiliary property; and
incorporating the assertion of the at least one auxiliary property into the accumulated assumption if the assumption of the at least one auxiliary property is present in the accumulated assumption;
wherein the starting assumption, the assumption, and the assertion describe a state of the digital circuit at predefined times.

15. The computer-readable storage medium of claim 14, wherein the assumption examination is performed when the accumulated assumption changes.

16. The computer-readable storage medium of claim 14, wherein the set of instructions further direct the computer system to perform the acts of:
determining interrelationships between at least two auxiliary properties, wherein the interrelationships indicate how the presence of the assumption of an auxiliary property necessitates the presence of the assumption of at least one other auxiliary property in a suitable time shift.

17. The computer-readable storage medium of claim 16, wherein the determining of the interrelationships is based on how the assertion of the auxiliary property includes the assumption of at least one other auxiliary property and/or how the presence of an assumption of an auxiliary property necessitates or rules out the presence of the assumption of at least one other auxiliary property.

18. The computer-readable storage medium of claim 14, wherein the set of instructions further direct the computer system to perform the acts of:
producing an activation matrix that determines for each auxiliary property whether the auxiliary property is activated, deactivated, or unknown at at least one time shift step of the at least one auxiliary property with respect to the starting assumption.

19. The computer-readable storage medium of claim 14, wherein the set of instructions further direct the computer system to perform the acts of:
dividing an auxiliary property into auxiliary properties such that the sum of the assertions of the auxiliary properties corresponds to the assertion of the auxiliary property and the sum of the assumptions of the auxiliary properties corresponds to the assumption of the auxiliary property;
wherein mutual causal dependencies of the divided auxiliary properties in the form of a prescribed activation sequence are taken into account in the activation of the individual parts of the auxiliary property.

20. The computer-readable storage medium of claim 18, wherein the set of instructions further direct the computer system to perform the acts of:
dividing an auxiliary property into auxiliary properties such that the sum of the assertions of the auxiliary properties corresponds to the assertion of the auxiliary property and the sum of the assumptions of the auxiliary properties corresponds to the assumption of the auxiliary property, wherein mutual causal dependencies of the divided auxiliary properties in the form of a prescribed activation sequence are taken into account in an activation of individual parts of the auxiliary property; and
apportioning a proof objective by automatic and controlled case differentiations when at least one auxiliary property is activated, wherein an individual accumulated assumption, an individual activation matrix and an individual correspondingly reduced assertion is generated for each case of the case differentiation.

21. The computer-readable storage medium of claim 19, wherein the set of instructions further direct the computer system to perform the acts of:
terminating the method if:
the accumulated assumption does not include an assumption of an auxiliary property and the enhancement of the accumulated assumption with partial conditions from case differentiations does not cause an activation of auxiliary properties;
the assertion of a proof objective has been completely invalidated;
all of the auxiliary properties which may still be activated with a suitable time shift are located outside the time window of a proof objective; or
the parts of the activation matrix based at a current time are identical to parts of the activation matrix at an earlier time, and the state of activation of the parts of the activation matrix may no longer be changed.

22. The computer-readable storage medium of claim 14, wherein the starting assumption is the assumption of a property to be proven and the starting assumption is examined to determine whether an assertion of the property to be proven is included in the accumulated assumption.

23. The computer-readable storage medium of claim 22, wherein the set of instructions further direct the computer system to perform the acts of:
replacing an assertion of the property to be proven with the assumption of the auxiliary property.

24. The computer-readable storage medium of claim 14, wherein the set of instructions further direct the computer system to perform the acts of:
replacing all state predicates occurring in the assumptions and assertions with unambiguous, uninterrupted symbols.

25. The computer-readable storage medium of claim 14, wherein causal dependency of the successively activated auxiliary properties are derived from a sequence of the activation of successively activated auxiliary properties.

26. The computer-readable storage medium of claim 25, wherein the set of instructions further direct the computer system to perform the acts of:
producing an activation matrix comprising for each auxiliary property whether the auxiliary property is activated, deactivated, or unknown at at least one time shift step of the auxiliary property with respect to the starting assumption;
retracing inconsistencies between the assertion and the accumulated assumption in a sequence of activated auxiliary assumptions; and
generating indications for possible completion of an amount of the auxiliary properties as a function of the accumulated assumption, at least one assertion, and the activation matrix.
